(19) United States
(12) Patent Application Publication
(10) Pub. No.: US 2014/0232662 A1
(43) Pub. Date: Aug. 21, 2014

(54) COMPUTING DEVICE HAVING A HAND CLEANLINESS SENSOR

(71) Applicant: ELWHA LLC, Bellevue, WA (US)

(72) Inventors: Paul Duesterhoft, Issaquah, WA (US); Roderick A. Hyde, Redmond, WA (US); Jordin T. Kare, Seattle, WA (US); Stephen L. Malaska, Redmond, WA (US); Robert C. Petroski, Seattle, WA (US); Lowell L. Wood, JR., Bellevue, WA (US)

(73) Assignee: Elwha LLC, Bellevue, WA (US)

(21) Appl. No.: 13/770,226

(22) Filed: Feb. 19, 2013

(51) Int. Cl. G06F 3/041

(52) U.S. Cl. CPC G06F 3/0412
USPC 345/173

(57) ABSTRACT

Described embodiments include a computing device. The computing device includes a touch-sensitive screen configured to accept an input from a hand of a person based upon a touch contact. The computing device includes a cleanliness sensor configured to detect an indicator of a pathogen present on the hand of the person contacting the touch-sensitive screen or present on the other hand of the person. The computing device includes a cleanliness notification circuit configured to output a signal responsive to the detected indicator of a pathogen.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application is related to and/or claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications,” if any, listed below.

### PRIORITY APPLICATIONS

None.

### RELATED APPLICATIONS

U.S. patent application Ser. No. ______, entitled WRITING IMPLEMENT SENSING A USER'S HAND CLEANLINESS, naming PAUL DUESTERHOFT, RODERICK A. HYDE, JORDIN T. KARE, ERIC C. LEUTHARDT, STEPHEN L. MALASKA, ROBERT PETROSKI, and LOWELL L. WOOD, JR. as inventors, filed 19, Feb., 2013 with attorney docket no. 0212-002-001-000000, is related to the present application.

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed Application, USPTO Official Gazette Mar. 18, 2003. The USPTO further has provided forms for the Application Data Sheet which allow automatic loading of bibliographic data but which require identification of each application as a continuation, continuation-in-part, or divisional of a parent application. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above and in any ADS filed in this application, but expressly points out that such designation(s) are not to be construed in any way as any type of commentary and/or admission as to whether or not the present application contains any new matter in addition to the matter of its parent application(s).

If the listings of applications provided above are inconsistent with the listings provided via an ADS, it is the intent of the Applicant to claim priority to each application that appears in the Priority Applications section of the ADS and to each application that appears in the Priority Applications section of this application.

All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

### SUMMARY

For example, and without limitation, an embodiment of the subject matter described herein includes a computing device. The computing device includes a touch-sensitive screen configured accept an input from a hand of a person based upon a touch contact. The computing device includes a cleanliness sensor configured to detect an indicator of a pathogen present on the hand of the person contacting the touch-sensitive screen or present on the other hand of the person. The computing device includes a cleanliness notification circuit configured to output a signal responsive to the detected indicator of a pathogen.

In an embodiment, the computing device includes a data combination circuit configured to associate an input sensed by the touch-sensitive screen from a touch by the person and the outputted signal responsive to the detected indicator of a pathogen. In an embodiment, the computing device includes a controller circuit configured to initiate a human perceivable indication of a possible contamination in response to the detected indicator of a pathogen. In an embodiment, the computing device includes an indicator element configured to broadcast a human perceivable indication responsive to the signal responsive to the detected indicator of a pathogen. In an embodiment, the computing device includes a healthcare apparatus physically coupled with or incorporating the computing device. In an embodiment, the computing device includes an operating system, a processor, and computer readable storage media.

For example, and without limitation, an embodiment of the subject matter described herein includes a method. The method includes sensing a hand of a person holding or touching a computing device having a touch-sensitive screen. The method includes detecting an indicator of a pathogen present on the sensed hand of the person. The method includes initiating a notification responsive to the detected indicator of a pathogen on the hand of the person. In an embodiment, the method includes associating an input accepted by the touch-sensitive screen from the hand of the person and the outputted signal responsive to the detected indicator of a pathogen.

For example, and without limitation, an embodiment of the subject matter described herein includes a system. The system includes means for sensing a hand of a person holding a computing device having a touch-sensitive screen. The system includes means for detecting an indicator of a pathogen present on the sensed hand of the person. The system includes means for initiating a notification responsive to the detected indicator of a pathogen on the hand of the person.

In an embodiment, the system includes means for associating an input accepted by the touch-sensitive screen from the hand of the person and the outputted signal responsive to the detected indicator of a pathogen. In an embodiment, the system includes means for broadcasting a human perceivable indication based on the signal responsive to the detected indicator of a pathogen.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 illustrates an example embodiment of a thin computing device in which embodiments may be implemented;

FIG. 2 illustrates an example embodiment of a general-purpose computing system in which embodiments may be implemented;

FIG. 3 illustrates an example environment 200;

FIG. 4 illustrates an example operational flow 300;

FIG. 5 illustrates an alternative embodiment of the operational flow 300 of FIG. 3;

FIG. 6 illustrates an example environment 400;

FIG. 7 illustrates an environment 500;

FIG. 8 illustrates an example operational flow 600; and

FIG. 9 illustrates an example system 700.

### DETAILED DESCRIPTION

In the following detailed description, reference is made to the accompanying drawings, which form a part hereof. In the drawings, similar symbols typically identify similar components, unless context dictates otherwise. The illustrated embodiments described in the detailed description, drawings, and claims are not meant to be limiting. Other embodiments may be utilized, and other changes may be made, without departing from the spirit or scope of the subject matter presented here.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various implementations by which processes and/or systems and/or other technologies described herein can be effected (e.g., hardware, software, and/or firmware), and that the preferred implementation will vary with the context in which the processes and/or systems and/or other technologies are deployed. For example, if an implementer determines that speed and accuracy are paramount, the implementer may opt for a mainly hardware and/or firmware implementation; alternatively, if flexibility is paramount, the implementer may opt for a mainly software implementation; or, yet again alternatively, the implementer may opt for some combination of hardware, software, and/or firmware. Hence, there are several possible implementations by which the processes and/or devices and/or other technologies described herein may be effected, none of which is inherently superior to the other in that any implementation to be utilized is a choice dependent upon the context in which the implementation will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include software or other control structures suitable to implement an operation. Electronic circuitry, for example, may manifest one or more paths of electrical current constructed and arranged to implement various logic functions as described herein. In some implementations, one or more media are configured to bear a device-detectable implementation if such media hold or transmit a special-purpose device instruction set operable to perform as described herein. In some variants, for example, this may manifest as an update or other modification of existing software or firmware, or of gate arrays or other programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or otherwise invoking circuitry for enabling, triggering, coordinating, requesting, or otherwise causing one or more occurrences of any functional operations described below. In some variants, operational or other logical descriptions herein may be expressed directly as source code and compiled or otherwise invoked as an executable instruction sequence. In some contexts, for example, C++ or other code sequences can be compiled directly or otherwise implemented in high-level descriptor languages (e.g., a logic-synthesizable language, a hardware description language, a hardware design simulation, and/or other such similar mode(s) of expression). Alternatively or additionally, some or all of the logical expression may be manifested as a Verilog-type hardware description or other circuitry model before physical implementation in hardware, especially for basic operations or timing-critical applications. Those skilled in the art will recognize how to obtain, configure, and optimize suitable transmission or computational elements, material supplies, actuators, or other common structures in light of these teachings.

In a general sense, those skilled in the art will recognize that the various embodiments described herein can be implemented, individually and/or collectively, by various types of electro-mechanical systems having a wide range of electrical components such as hardware, software, firmware, and/or virtually any combination thereof; and a wide range of components that may impart mechanical force or motion such as rigid bodies, spring or torsional bodies, hydraulics, electro-magnetically actuated devices, and/or virtually any combination thereof. Consequently, as used herein “electro-mechanical system” includes, but is not limited to, electrical circuitry operably coupled with a transducer (e.g., an actuator, a motor, a piezoelectric crystal, a Micro Electro Mechanical System (MEMS), etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, module, communications switch, optical-electrical equipment, etc.), and/or any non-electrical analog thereto, such as optical or other analogs. Those skilled in the art will also appreciate that examples of electro-mechanical systems include but are not limited to a variety of consumer electronics systems, medical devices, as well as other systems such as motorized transport systems, factory automation systems, security systems, and/or communication/computing systems. Those skilled in the art will recognize that electro-mechanical as used herein is not necessarily limited to a system that has both electrical and mechanical actuation except as context may dictate otherwise.

In a general sense, those skilled in the art will also recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

Those skilled in the art will further recognize that at least a portion of the devices and/or processes described herein can be integrated into an image processing system. A typical image processing system may generally include one or more of a system unit housing, a video display device, memory such as volatile or non-volatile memory, processors such as microprocessors or digital signal processors, computational entities such as operating systems, drivers, applications programs, one or more interaction devices (e.g., a touch pad, a touch-sensitive screen or display surface, an antenna, etc.), control systems including feedback loops and control motors (e.g., feedback for sensing lens position and/or velocity; control motors for moving/distorting lenses to give desired focuses). An image processing system may be implemented utilizing suitable commercially available components, such as those typically found in digital still systems and/or digital motion systems.

Those skilled in the art will likewise recognize that at least some of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch-sensitive screen or display surface, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

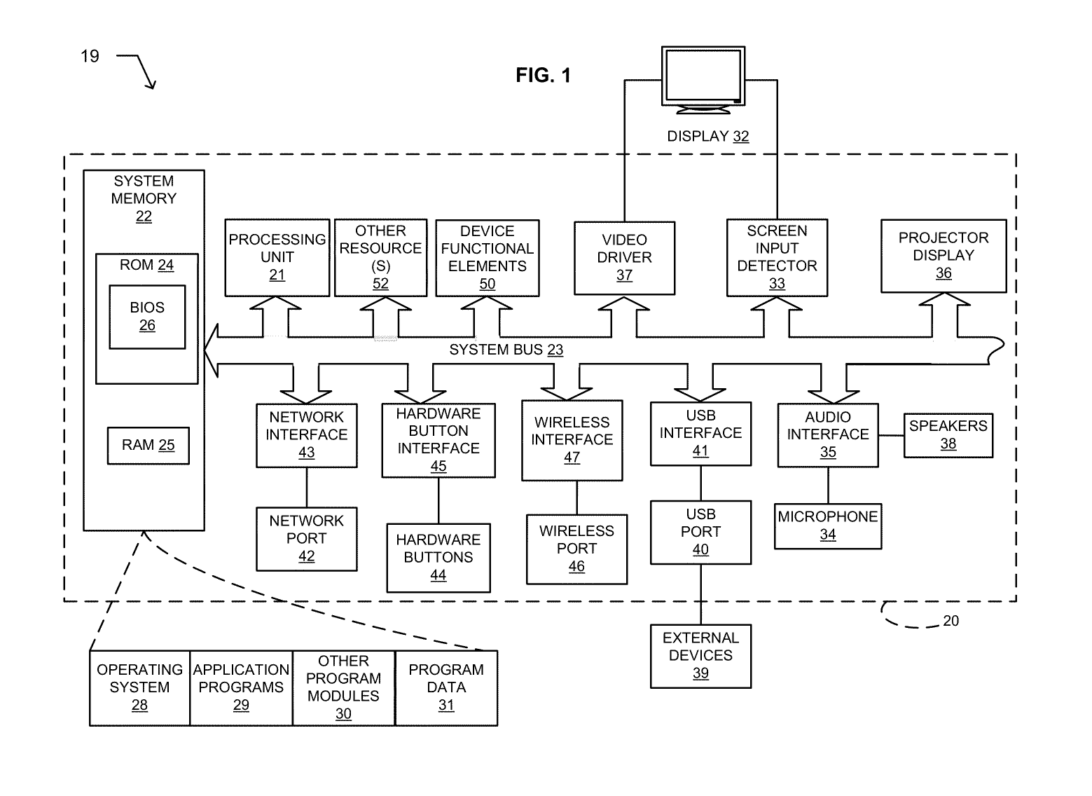

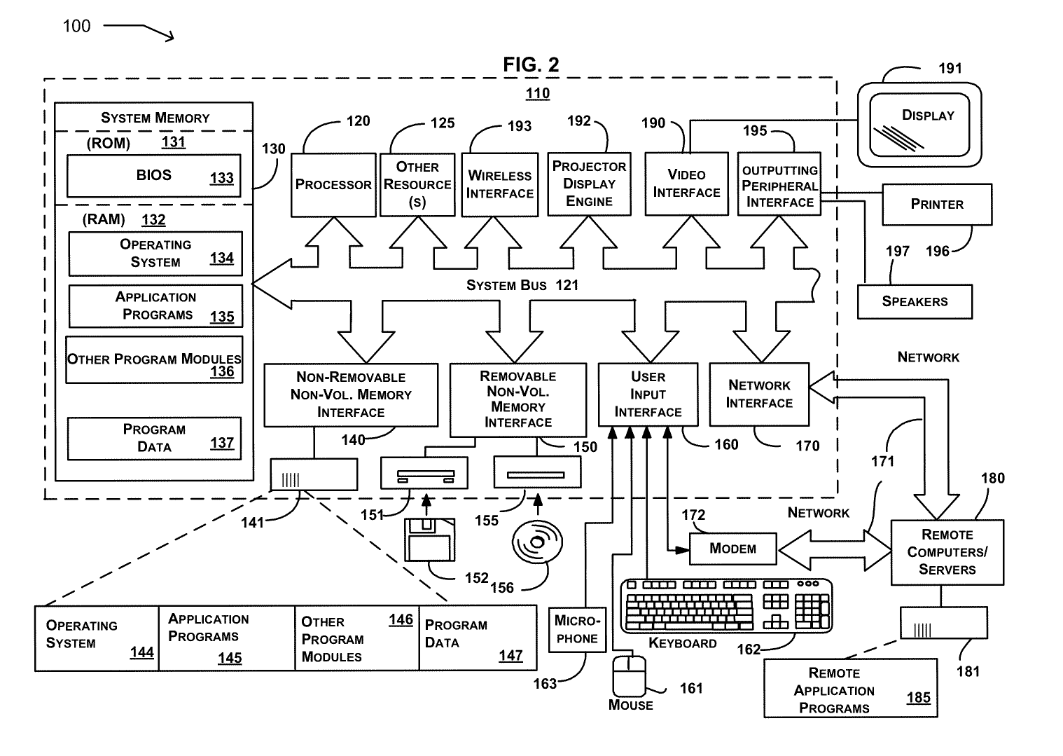

FIGS. 1 and 2 provide respective general descriptions of several environments in which implementations may be implemented. FIG. 1 is generally directed toward a thin computing environment 19 having a thin computing device 20, and FIG. 2 is generally directed toward a general purpose computing environment 100 having general purpose computing device 110. However, as prices of computer components drop and as capacity and speeds increase, there is not always a bright line between a thin computing device and a general purpose computing device. Further, there is a continuous stream of new ideas and applications for environments benefited by use of computing power. As a result, nothing should be construed to limit disclosed subject matter herein to a specific computing environment unless limited by express language.

FIG. 1 and the following discussion are intended to provide a brief, general description of a thin computing environment 19 in which embodiments may be implemented. FIG. 1 illustrates an example system that includes a thin computing device 20, which may be included or embedded in an electronic device that also includes a device functional element 50. For example, the electronic device may include any item having electrical or electronic components playing a role in a functionality of the item, such as for example, a refrigerator, a car, a digital image acquisition device, a camera, a cable modem, a printer an ultrasound device, an x-ray machine, a non-invasive imaging device, or an airplane. For example, the electronic device may include any item that interfaces with or controls a functional element of the item. In another example, the thin computing device may be included in an implantable medical apparatus or device. In a further example, the thin computing device may be operable to communicate with an implantable or implanted medical apparatus. For example, a thin computing device may include a computing device having limited resources or limited processing capability, such as a limited resource computing device, a wireless communication device, a mobile wireless communication device, a smart phone, an electronic pen, a handheld electronic writing device, a scanner, a cell phone, a smart phone (such as an Android® or iPhone® based device), a tablet device (such as an iPad®) or a Blackberry® device. For example, a thin computing device may include a thin client device or a mobile thin client device, such as a smart phone, tablet, notebook, or desktop hardware configured to function in a virtualized environment.

The thin computing device 20 includes a processing unit 21, a system memory 22, and a system bus 23 that couples various system components including the system memory 22 to the processing unit 21. The system bus 23 may be any of several types of bus structures including a memory bus or memory controller, a peripheral bus, and a local bus using any of a variety of bus architectures. The system memory includes read-only memory (ROM) 24 and random access memory (RAM) 25. A basic input/output system (BIOS) 26, containing the basic routines that help to transfer information between sub-components within the thin computing device 20, such as during start-up, is stored in the ROM 24. A number of program modules may be stored in the ROM 24 or RAM 25, including an operating system 28, one or more application programs 29, other program modules 30 and program data 31.

A user may enter commands and information into the computing device 20 through one or more input interfaces. An input interface may include a touch-sensitive screen or display surface, or one or more switches or buttons with suitable input detection circuitry. A touch-sensitive screen or display surface is illustrated as a touch-sensitive display 32 and screen input detector 33. One or more switches or buttons are illustrated as hardware buttons 44 connected to the system via a hardware button interface 45. The output circuitry of the touch-sensitive display 32 is connected to the system bus 23 via a video driver 37. Other input devices may include a microphone 34 connected through a suitable audio interface 35, or a physical hardware keyboard (not shown). Output devices may include the display 32, or a projector display 36.

In addition to the display 32, the computing device 20 may include other peripheral output devices, such as at least one speaker 38. Other external input or output devices 39, such as a joystick, game pad, satellite dish, scanner or the like may be connected to the processing unit 21 through a USB port 40 and USB port interface 41, to the system bus 23. Alternatively, the other external input and output devices 39 may be connected by other interfaces, such as a parallel port, game port or other port. The computing device 20 may further include or be capable of connecting to a flash card memory (not shown) through an appropriate connection port (not shown). The computing device 20 may further include or be capable of connecting with a network through a network port 42 and network interface 43, and through wireless port 46 and corresponding wireless interface 47 may be provided to facilitate communication with other peripheral devices, including other computers, printers, and so on (not shown). It will be appreciated that the various components and connections shown are examples and other components and means of establishing communication links may be used.

The computing device 20 may be primarily designed to include a user interface. The user interface may include a character, a key-based, or another user data input via the touch sensitive display 32. The user interface may include using a stylus (not shown). Moreover, the user interface is not limited to an actual touch-sensitive panel arranged for directly receiving input, but may alternatively or in addition respond to another input device such as the microphone 34. For example, spoken words may be received at the microphone 34 and recognized. Alternatively, the computing device 20 may be designed to include a user interface having a physical keyboard (not shown).

The device functional elements 50 are typically application specific and related to a function of the electronic device, and are coupled with the system bus 23 through an interface (not shown). The functional elements may typically perform a single well-defined task with little or no user configuration or setup, such as a refrigerator keeping food cold, a cell phone connecting with an appropriate tower and transceiving voice or data information, a camera capturing and saving an image, or communicating with an implantable medical apparatus.

In certain instances, one or more elements of the thin computing device 20 may be deemed not necessary and omitted. In other instances, one or more other elements may be deemed necessary and added to the thin computing device.

FIG. 2 and the following discussion are intended to provide a brief, general description of an environment in which embodiments may be implemented. FIG. 2 illustrates an example embodiment of a general-purpose computing system in which embodiments may be implemented, shown as a computing system environment 100. Components of the computing system environment 100 may include, but are not limited to, a general purpose computing device 110 having a processor 120, a system memory 130, and a system bus 121 that couples various system components including the system memory to the processor 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

The computing system environment 100 typically includes a variety of computer-readable media products. Computer-readable media may include any media that can be accessed by the computing device 110 and include both volatile and nonvolatile media, removable and non-removable media. By way of example, and not of limitation, computer-readable media may include computer storage media. By way of further example, and not of limitation, computer-readable media may include a communication media.

Computer storage media includes volatile and nonvolatile, removable and non-removable media implemented in any method or technology for storage of information such as computer-readable instructions, data structures, program modules, or other data. Computer storage media includes, but is not limited to, random-access memory (RAM), read-only memory (ROM), electrically erasable programmable read-only memory (EEPROM), flash memory, or other memory technology, CD-ROM, digital versatile disks (DVD), or other optical disk storage, magnetic cassettes, magnetic tape, magnetic disk storage, or other magnetic storage devices, or any other medium which can be used to store the desired information and which can be accessed by the computing device 110. In a further embodiment, a computer storage media may include a group of computer storage media devices. In another embodiment, a computer storage media may include an information store. In another embodiment, an information store may include a quantum memory, a photonic quantum memory, or atomic quantum memory. Combinations of any of the above may also be included within the scope of computer-readable media.

Communication media may typically embody computer-readable instructions, data structures, program modules, or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communications media may include wired media, such as a wired network and a direct-wired connection, and wireless media such as acoustic, RF, optical, and infrared media.

The system memory 130 includes computer storage media in the form of volatile and nonvolatile memory such as ROM 131 and RAM 132. A RAM may include at least one of a DRAM, an EDO DRAM, a SDRAM, a RDRAM, a VRAM, or a DDR DRAM. A basic input/output system (BIOS) 133, containing the basic routines that help to transfer information between elements within the computing device 110, such as during start-up, is typically stored in ROM 131. RAM 132 typically contains data and program modules that are immediately accessible to or presently being operated on by the processor 120. By way of example, and not limitation, FIG. 2 illustrates an operating system 134, application programs 135, other program modules 136, and program data 137. Often, the operating system 134 offers services to applications programs 135 by way of one or more application programming interfaces (APIs) (not shown). Because the operating system 134 incorporates these services, developers of applications programs 135 need not redevelop code to use the services. Examples of APIs provided by operating systems such as Microsoft's “WINDOWS” ® are well known in the art.

The computing device 110 may also include other removable/non-removable, volatile/nonvolatile computer storage media products. By way of example only, FIG. 2 illustrates a non-removable non-volatile memory interface (hard disk interface) 140 that reads from and writes for example to non-removable, non-volatile magnetic media. FIG. 2 also illustrates a removable non-volatile memory interface 150 that, for example, is coupled to a magnetic disk drive 151 that reads from and writes to a removable, non-volatile magnetic disk 152, or is coupled to an optical disk drive 155 that reads from and writes to a removable, non-volatile optical disk 156, such as a CD ROM. Other removable/non-removable, volatile/non-volatile computer storage media that can be used in the example operating environment include, but are not limited to, magnetic tape cassettes, memory cards, flash memory cards, DVDs, digital video tape, solid state RAM, and solid state ROM. The hard disk drive 141 is typically connected to the system bus 121 through a non-removable memory interface, such as the interface 140, and magnetic disk drive 151 and optical disk drive 155 are typically connected to the system bus 121 by a removable non-volatile memory interface, such as interface 150.

The drives and their associated computer storage media discussed above and illustrated in FIG. 2 provide storage of computer-readable instructions, data structures, program modules, and other data for the computing device 110. In FIG. 2, for example, hard disk drive 141 is illustrated as storing an operating system 144, application programs 145, other program modules 146, and program data 147. Note that these components can either be the same as or different from the operating system 134, application programs 135, other program modules 136, and program data 137. The operating system 144, application programs 145, other program modules 146, and program data 147 are given different numbers here to illustrate that, at a minimum, they are different copies.

A user may enter commands and information into the computing device 110 through input devices such as a microphone 163, keyboard 162, and pointing device 161, commonly referred to as a mouse, trackball, or touch pad. Other input devices (not shown) may include at least one of a touch-sensitive screen or display surface, joystick, game pad, satellite dish, and scanner. These and other input devices are often connected to the processor 120 through a user input interface 160 that is coupled to the system bus, but may be connected by other interface and bus structures, such as a parallel port, game port, or a universal serial bus (USB).

A display 191, such as a monitor or other type of display device or surface may be connected to the system bus 121 via an interface, such as a video interface 190. A projector display engine 192 that includes a projecting element may be coupled to the system bus. In addition to the display, the computing device 110 may also include other peripheral output devices such as speakers 197 and printer 196, which may be connected through an output peripheral interface 195.

The computing system environment 100 may operate in a networked environment using logical connections to one or more remote computers, such as a remote computer 180. The remote computer 180 may be a personal computer, a server, a router, a network PC, a peer device, or other common network node, and typically includes many or all of the elements described above relative to the computing device 110, although only a memory storage device 181 has been illustrated in FIG. 2. The network logical connections depicted in FIG. 2 include a local area network (LAN) and a wide area network (WAN), and may also include other networks such as a personal area network (PAN) (not shown). Such networking environments are commonplace in offices, enterprise-wide computer networks, intranets, and the Internet.

When used in a networking environment, the computing system environment 100 is connected to the network 171 through a network interface, such as the network interface 170, the modem 172, or the wireless interface 193. The network may include a LAN network environment, or a WAN network environment, such as the Internet. In a networked environment, program modules depicted relative to the computing device 110, or portions thereof, may be stored in a remote memory storage device. By way of example, and not limitation, FIG. 2 illustrates remote application programs 185 as residing on memory storage device 181. It will be appreciated that the network connections shown are examples and other means of establishing a communication link between the computers may be used.

In certain instances, one or more elements of the computing device 110 may be deemed not necessary and omitted. In other instances, one or more other elements may be deemed necessary and added to the computing device.

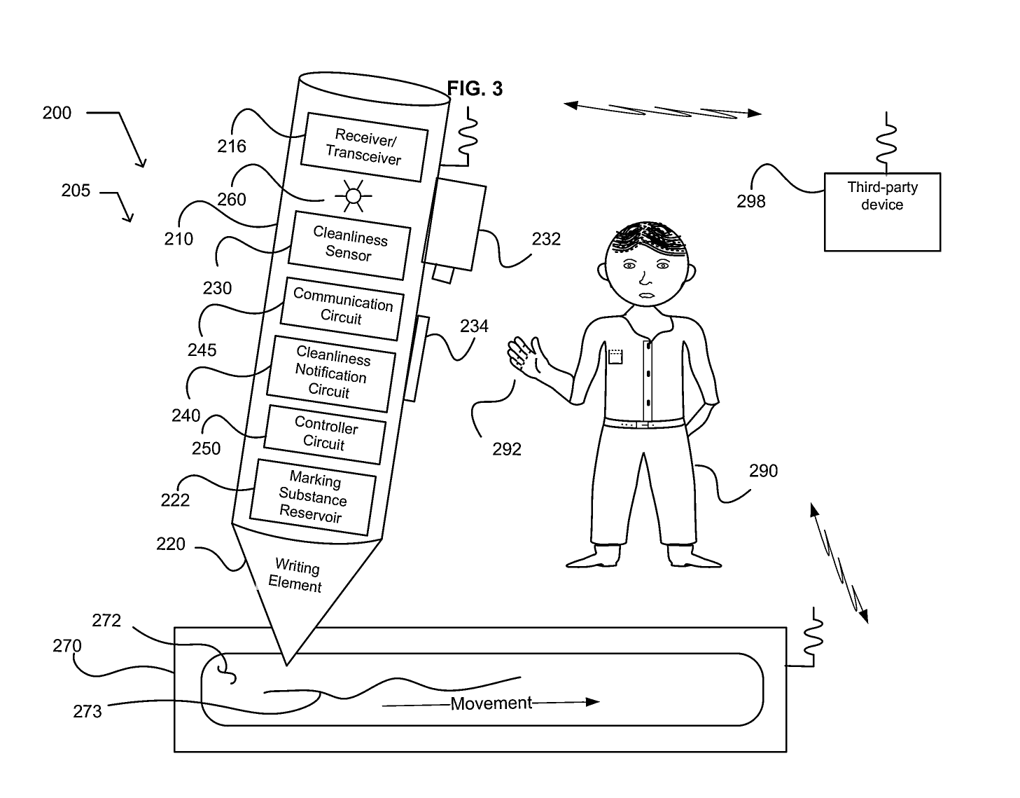

FIG. 3 illustrates an example environment 200 in which embodiments may be implemented. The environment includes a hand-holdable device 205, a person 290, a device 270 having a surface 272, and a third-party device 298. The hand-holdable device includes a hand-holdable housing 210 carrying a writing element 220, a cleanliness sensor 230, and a cleanliness notification circuit 240. The writing element is configured to form a mark on a surface in response to a touch or movement of the writing element with respect to the surface. FIG. 3 illustrates an embodiment of the writing element configured to form a mark 273 on the surface 272 in response to a movement of the writing element with respect to the surface. In other embodiment, the surface may include other types of surfaces as described below. The cleanliness sensor is configured to detect an indicator of a pathogen present on a hand 292 of the person holding the hand-holdable housing. In an embodiment, a pathogen includes something that can cause a disease, i.e., a bacterium or virus, or have a toxic effect on a human. The cleanliness notification circuit is configured to output a signal responsive to the detected indicator of a pathogen on the hand of the person. In an embodiment, the signal may be outputted to the third-party device using a receiver/transceiver 216. In an embodiment, the signal may be outputted to a controller circuit 250, the writing element 220, or the device 270.

In an embodiment, the hand-holdable housing 210 includes an elongated and hand-holdable housing. In an embodiment, the writing element 220 includes a portion structured to interact with a touch-sensitive surface of a touch screen of a computing device, such as for example, the surface 272 of the device 270. A touch-sensitive surface, a touch-sensitive display, and a touch screen of a computing device are described in U.S. Pat. No. 7,479,949 (Jobs, et al.). In an embodiment, the device 270 may include a thin computing device, such as the thin computing device 20 described in conjunction with in FIG. 1, or a general purpose computing device, such as the general purpose computing device 110 described in conjunction with FIG. 2. In an embodiment, the writing element includes a portion structured to form a virtual mark on a touch-sensitive surface of a touch screen of a computing device. In an embodiment, the writing element includes a portion structured to form a physical mark on a paper surface. For example, a physical mark may include a mark formed by a pen on paper or other writable surface. In an embodiment, the writing element includes a portion configured to discharge a marking substance on a surface in response to a movement of the writing element with respect to a surface. For example, the marking substance may be sourced from a marking substance reservoir 222. In an embodiment, the writing element includes a portion configured to discharge at least one of ink, graphite, paint, particles, nanoparticles, and/or quantum dots marking substance on a surface in response to a movement of the writing element with respect to a surface. In an embodiment, the writing element includes a portion configured to impart a detectable touch to a touch-sensitive screen of an electronic device. For example, a virtual mark. For example, a detectable touch of the writing element to the touch-sensitive screen 272 may in cooperation with the device 270 form an electronic mark or a virtual mark, or may facilitate or effectuate an input to the device 270. For example, a detectable touch of the writing element may select a particular visual output by the touch-sensitive screen, or may input a user selection into the touch screen electronic device. In an embodiment, the writing element includes a portion configured to impart a detectable touch to a touch-sensitive screen of an electronic device and to effectuate an input to the electronic device. In an embodiment, the writing element includes a portion configured to impart a detectable touch to a portion of a touch-sensitive screen of an electronic device displaying a particular visual output. In an embodiment, the writing element includes at least one of a tip, an application element, a nozzle, or a nib and being configured to form a mark on a surface in response to a movement of the writing element with respect to the surface. In an embodiment, the writing element includes a portion configured to at least one of emit, dispose, impart, release, eject, and/or flow a marking substance on a surface in response to a movement of the writing element with respect to the surface.

In an embodiment, the surface includes a skin, layer, glass, paper, metal, plastic, and/or composite surface. In an embodiment, the surface includes a surface of a container, a package container, a living body, a human body, and/or an object surface. In an embodiment, the writing element 220 is configured to cause a thermal marking process on a surface in response to a movement of the writing element with respect to the surface. In an embodiment, the writing element includes a portion configured to cause a marking interaction with a media in response to a movement of the writing element with respect to the media. In an embodiment, the surface includes a touch-sensitive surface of a touch screen of a computing device, and the writing element is configured to facilitate the computing device displaying a mark on the touch screen responsive to a contact between the writing element and the touch-sensitive surface.

In an embodiment, the cleanliness sensor 210 includes a cleanliness sensor configured to detect in substantially real-time an indicator of a pathogen present on the hand 292 of the person 290 holding the hand-holdable housing 210. In an embodiment, the cleanliness sensor includes a cleanliness sensor configured to initiate in response to sensing criteria a detection of an indicator of a pathogen present on a hand of a person holding the hand-holdable housing. For example, a sensing criteria may include time of day, a movement of the hand-holdable housing, or an identity of the person. In an embodiment, the cleanliness sensor includes a cleanliness sensor configured to detect a cleanliness surrogate indicative of a pathogen present on or absent from a hand of a person holding the hand-holdable housing. For example, the cleanliness sensor may detect dirt, sweat, or other residue as a cleanliness indicator or as a surrogate for actual bio-detection of pathogens. For example, the cleanliness sensor may detect a contamination, i.e. chemicals or radiation. In an embodiment, the cleanliness surrogate includes a marker transmitted by a hand cleansing formulation present to the hand of the person holding the hand-holdable housing. For example, U.S. Pat. App. 20090237651 (Arndt et al.) describes a hand cleansing formulation that includes a marker agent. For example, the cleanliness sensor 230 may include a sensor element 234 positioned in a gripping region configured to detect a marker applied during hand washing. A presence or concentration of the marker can serve as a cleanliness surrogate. In an embodiment, the marker may be invisible to an unaided human eye, but detectable spectroscopically. In an embodiment, markers may be changed periodically to provide information on the timing of hand washing events. In an embodiment, the marker includes a marker whose detectability decreases over time after an application or a dispensing to a person's hand. In an embodiment, the marker includes a marker having a time-variable component. (i.e., it doesn't lose detectability, detectability changes over time from state A to state B.) In an embodiment, the cleanliness surrogate includes an excretion or buildup normally present on a hand of a person and generally removed by a hand cleansing. For example, the cleanliness surrogate may include sweat, dirt, food particles. For example, a surface contamination sensor is described in U.S. Pat. No. 5,062,707 (Adler-Golden et al.). In an embodiment, the surface contamination sensor may have particular applicability to a touch screen implementation.

In an embodiment, the cleanliness sensor 230 includes an electronic nose configured to detect an indicator of a pathogen present on a hand of a person holding the hand-holdable housing. For example, an electronic nose is described in D. Ivnitski et al., Biosensors for detection of pathogenic bacteria, 14 Biosensors & Bioelectronics 599, 614 (1999). In an embodiment, the cleanliness sensor is configured to detect a skin condition possibly indicative of a pathogen present on a hand of a person holding the hand-holdable housing. For example, an image sensor 232 may be used to detect a skin condition. For example, detecting a skin condition is described in U.S. Pat. App. Pub. No. 20040220538 (Panopoulos). In an embodiment, the cleanliness sensor includes a sensor pad 234 carried on an exterior surface of the hand-holdable housing and configured to detect an indicator of a pathogen present on a hand of a person holding the hand-holdable housing. For example, a sensor pad is described in U.S. Pat. App. Pub. No. 20040220538 (Panopoulos). In an embodiment, the sensor pad is disposable. In an embodiment, the cleanliness sensor includes a wetness sensitive polymer carried on an exterior surface of the hand-holdable housing and configured to detect an indicator of a pathogen present on a hand of a person holding the hand-holdable housing. For example, a wetness sensor is described in U.S. Pat. App. Pub. No. 20090198202 (Nedestam). In an embodiment, the cleanliness sensor includes a real-time optical pathogen sensor configured to detect an indicator of a pathogen present on a hand of a person holding the hand-holdable housing. For example, a real-time optical pathogen sensor is described in U.S. Pat. App. Pub. No 20050118704. In an embodiment, the cleanliness sensor includes a biosensor configured to detect an indicator of a pathogen present on a hand of a person holding the hand-holdable housing. For example, a waste contamination sensor is described in U.S. Pat. No. 6,501,002 (Roe et al.). In an embodiment, the biosensor includes a disposable biosensor. For example, in an embodiment, disposable includes an article not intended to be laundered or otherwise not restored or reused after a single use. In an embodiment, the cleanliness sensor includes a piezoelectric sensor configured to detect small molecules. For example, a small molecule piezoelectric sensor is described in U.S. Pat. No. 7,135,295 (Willner et al.).

In an embodiment, the cleanliness sensor 230 includes a microbe-sensitive chromogen that undergoes a detectable color change in the presence of one or more microbes. For example, a microbe-sensitive chromogen that undergoes a detectable color change in the presence of one or more microbes is described in U.S. Pat. No. 7,300,770 (Martin et al.) In an embodiment, the microbe-sensitive chromogen includes a microbe-sensitive chromogen selected to effectively interact in a healthcare environment with the skin of a hand of a person holding or using the hand-holdable housing 210. In an embodiment, the cleanliness sensor includes an impedimetric biosensor configured to detect an indicator of a pathogen present on a hand of a person holding the hand-holdable housing. For examples of impedimetric biosensors, see Yixian Wang, et al., New Trends in Impedimetric Biosensors for the Detection of Foodborne Pathogenic Bacteria, Sensors 2012, 12, 3449-3471 (doi:10.3390/s120303449).

In an embodiment, the cleanliness notification circuit 240 includes a cleanliness notification circuit configured to output a signal responsive to the detected indicator of a pathogen on the hand 292 of the person 290 holding the hand-holdable housing 210 to a controller circuit 250 configured to inactivate the writing element 220. In an embodiment, the cleanliness notification circuit includes a cleanliness notification circuit configured to output in substantially real time a signal responsive to the detected indicator of a pathogen on the hand of the person.

In an embodiment, the hand-holdable device 205 further includes the controller circuit 250 configured to inactivate the writing element 220 in response to the detected indicator of a pathogen. In an embodiment, the controller circuit is configured to encode the mark 273 formed on the surface by the writing element with information indicative of the detected indicator of a pathogen. For example, encoding may include changing a color of the mark, making the mark intermittent, or adding specialty marks or symbols. In an embodiment, the encoding can be detected by unaided or unaugmented human vision. For example, a person reading the writing will be able to see the encoding, or the encoding may be automatically read by a device electronically coupled with the surface. For example, encoding may be performed by the hand-holdable device or by the device 270.

In an embodiment, the cleanliness notification circuit 240 includes a cleanliness notification circuit configured to wirelessly output a signal responsive to the detected indicator of a pathogen on the hand 292 of the person 290 holding the hand-holdable housing 210 to a computing device. For example, in an embodiment, the receiver/transceiver 216 may wirelessly output the signal to a computing device, illustrated as the third-party device 298. In an embodiment, the wirelessly outputted signal includes a radio signal. In an embodiment, the outputted signal includes a signal encoded in a mark 273 formed on the surface 272 by the writing element 220. For example, a signal may include ultrasonic vibrations in the writing element, or a variation in the color of the mark. In an embodiment, the cleanliness notification circuit includes a cleanliness notification circuit configured to output a signal responsive to the detected indicator of a pathogen on the hand of the person holding the hand-holdable housing to an indicator element carried by the hand-holdable housing. For example, the indicator element may include an indicator element 260. In an embodiment, the hand-holdable device 205 includes the indicator element carried by the hand-holdable housing and configured to broadcast a human perceivable indication in response to the signal responsive to the detected indicator of a pathogen on the hand of the person holding the hand-holdable housing. In an embodiment, the human perceivable indication includes a visual indication, an audible indication, or a haptic indication. In an embodiment, the cleanliness notification circuit includes a cleanliness notification circuit configured to output a signal responsive to the detected indicator of a pathogen on the hand of the person holding the hand-holdable housing to the third-party device 298. In an embodiment, the cleanliness notification circuit includes a cleanliness notification circuit configured to output to the third-party device a signal responsive to the detected indicator of a pathogen on the hand of the person holding the hand-holdable housing, and indicative of a context in which the detection occurred. For example, this may be used to track the travel of a contaminated person throughout a facility, and may aid in determining who or what the person has come in contact with, both to see who the person infects, or who infected the person. In an embodiment, the context includes a time when the indicator of a pathogen was detected. In an embodiment, the context includes a geographic location of the device when the indicator of a pathogen was detected. For example, a geographic location may include a location within a healthcare facility, i.e., room 473 of a named hospital. In an embodiment, the context includes an identifier of the device detecting the indicator of a pathogen. In an embodiment, the context includes an identifier of the person holding the device when the indicator of a pathogen was detected. In an embodiment, the hand-holdable device 205 includes a communication circuit 245.

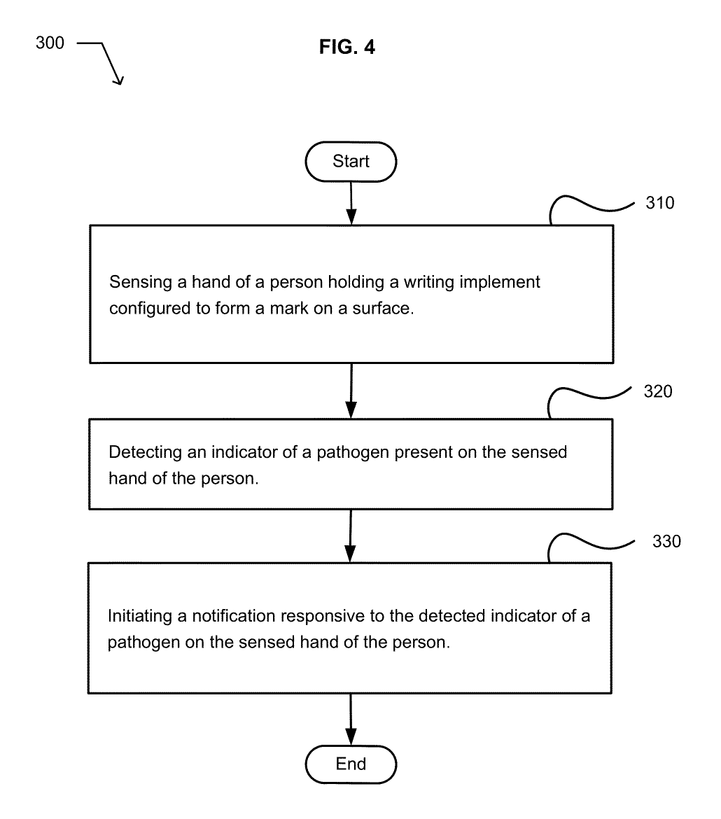

FIG. 4 illustrates an example operational flow 300. After a start operation, the operational flow includes an acquisition operation 310. The acquisition operation includes sensing a hand of a person holding a writing implement configured to form a mark on a surface. In an embodiment, the acquisition operation may be implemented using the cleanliness sensor 210 described in conjunction with FIG. 3. An ascertainment operation 320 includes detecting an indicator of a pathogen present on the sensed hand of the person. In an embodiment, the ascertainment operation may be implemented using the cleanliness sensor 210 described in conjunction with FIG. 3. A report operation 330 includes initiating a notification responsive to the detected indicator of a pathogen on the sensed hand of the person. In an embodiment, the report operation may be implemented using the cleanliness notification circuit 240 described in conjunction with FIG. 3. The operational flow includes an end operation.

In an embodiment, the acquisition operation 310 includes sensing a hand of a person holding a writing implement configured to form a mark on a surface in response to a movement of a writing element of the writing implement with respect to the surface. In an embodiment, the sensing includes sensing a hand of a person holding a writing implement in response to sensing criteria. In an embodiment, the sensing criteria include a sensing schedule. For example, a sensing schedule may include sensing based upon a fixed interval of time, such as every 5 minutes. For example, the writing implement may include a timer or locational sensor which triggers sensing. In an embodiment, the sensing criteria include an event. For example, an event may include a touch of the writing element to the surface, or a touch after a specified time interval of no touches. For example, an event may include a holding or gripping of the hand-holdable housing by the hand of a person. In an embodiment, the sensing criteria include a presence of the writing implement or the person at a specified geographic location. In an embodiment, the sensing criteria include sensing each time the person enters a room or other space. In an embodiment, the sensing criteria include an identification of the person. For example, the sensing criteria may include: “test person A more frequently than person B”. For example, a sensing criterion may include: “test whenever new user picks up the writing implement”. In an embodiment, the sensing criteria include sensing criteria based on a past location of the person. For example, the sensing criteria may include: “test if the person came from a high contamination location, or just entered the heath care facility where the surface is located”.

In an embodiment, the ascertainment operation 320 includes detecting in substantially real-time an indicator of a pathogen present on the hand of the person. In an embodiment, the detecting includes detecting a cleanliness surrogate indicative of a pathogen present on the hand of the person. In an embodiment, the detecting includes electronically detecting odors or flavors indicative of a pathogen present on the hand of the person. For example, this operation may be implemented using an electronic nose device. In an embodiment, the detecting includes electronically detecting airborne particles indicative of a pathogen present on the hand of the person. In an embodiment, the detecting includes detecting an indicator of a pathogen present on the hand of the person using a wetness sensitive polymer. In an embodiment, the detecting includes detecting an indicator of a pathogen present on the hand of the person using a real-time optical pathogen sensor. In an embodiment, the detecting includes detecting an indicator of a pathogen present on the hand of the person using a biosensor. In an embodiment, the detecting includes detecting an indicator of a pathogen present on the hand of the person using a piezoelectric sensor. In an embodiment, the detecting includes detecting an indicator of a pathogen present on the hand of the person using a microbe-sensitive chromogen that undergoes a detectable color change in the presence of one or more microbes. In an embodiment, the detecting includes detecting an indicator of a pathogen present on the hand of the person using an impedimetric biosensor.

In an embodiment, the report operation 330 includes initiating a human-perceivable notification responsive to the detected indicator of a pathogen on the hand of the person. In an embodiment, the initiating includes transforming the detected indicator of a pathogen on the hand of the person into a particular visual indication of the detected indicator of a pathogen on the hand of the person, and outputting the particular visual indication. In an embodiment, the initiating includes transforming the detected indicator of a pathogen on the hand of the person into data usable in displaying a particular visual indication of the detected indicator of a pathogen on the hand of the person. In an embodiment, the initiating includes transforming the detected indicator of a pathogen on the hand of the person into a particular visual depiction of the detected indicator of a pathogen on the hand of the person, and outputting the particular visual depiction. In an embodiment, the initiating includes initiating a notification to at least one of a human, computer, or system in response to the detected indicator of a pathogen on the hand of the person. In an embodiment, the initiating includes providing a notification to at least one of a human, computer, or system in response to the detected indicator of a pathogen on the hand of the person. In an embodiment, the initiating includes electronically outputting information indicative of the detected indicator of a pathogen on the hand of the person. In an embodiment, the information is further indicative of a context in which the detection occurred. In an embodiment, the initiating includes initiating a visual notification by a device containing the surface. In an embodiment, the initiating includes initiating a visual notification by the writing implement. In an embodiment, the initiating includes initiating a visual notification by a third-party device. In an embodiment, the initiating includes electronically outputting a signal useable in displaying a human-perceivable indication of the detected indicator of a pathogen on the hand of the person.

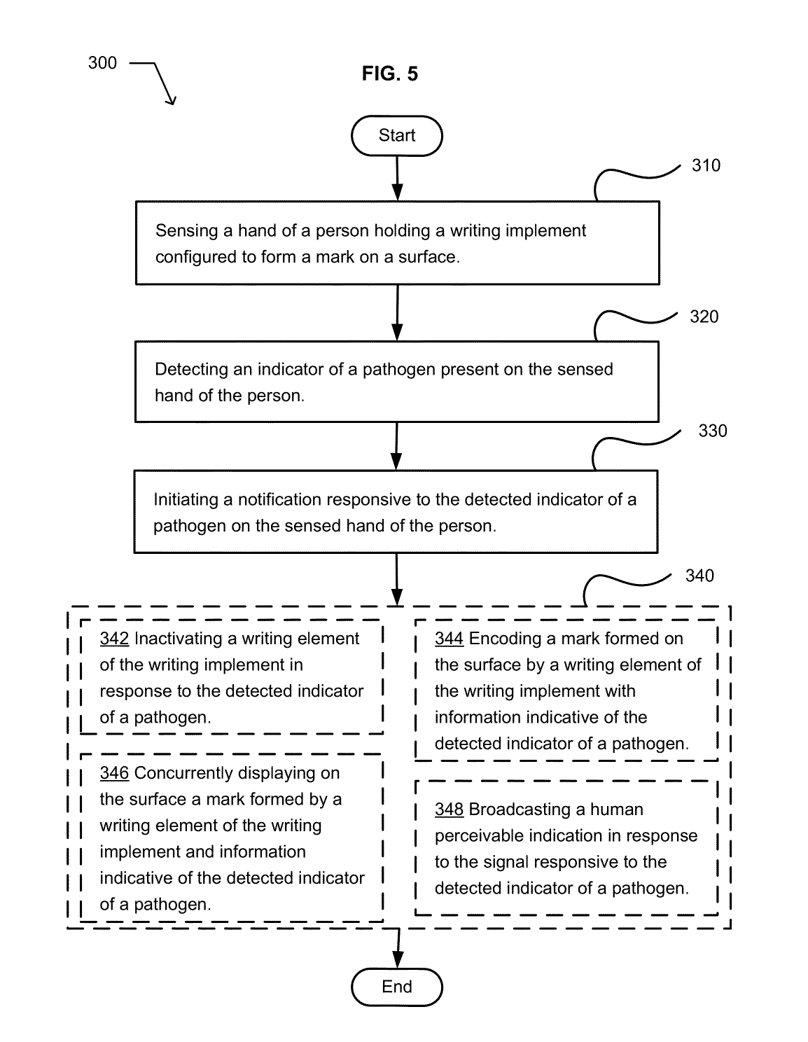

FIG. 5 illustrates an alternative embodiment of the operational flow 300 of FIG. 3. The alternative embodiment includes at least one additional operation 340. The at least one additional operation may include an operation 342, an operation 344, an operation 346, or an operation 348. The operation 342 includes inactivating a writing element of the writing implement in response to the detected indicator of a pathogen. The operation 344 includes encoding a mark formed on the surface by a writing element of the writing implement with information indicative of the detected indicator of a pathogen. The operation 346 includes concurrently displaying on the surface a mark formed by a writing element of the writing implement and information indicative of the detected indicator of a pathogen. For example, the information may include a text message, an icon, or a change in background color. The operation 348 includes broadcasting a human perceivable indication in response to the signal responsive to the detected indicator of a pathogen.

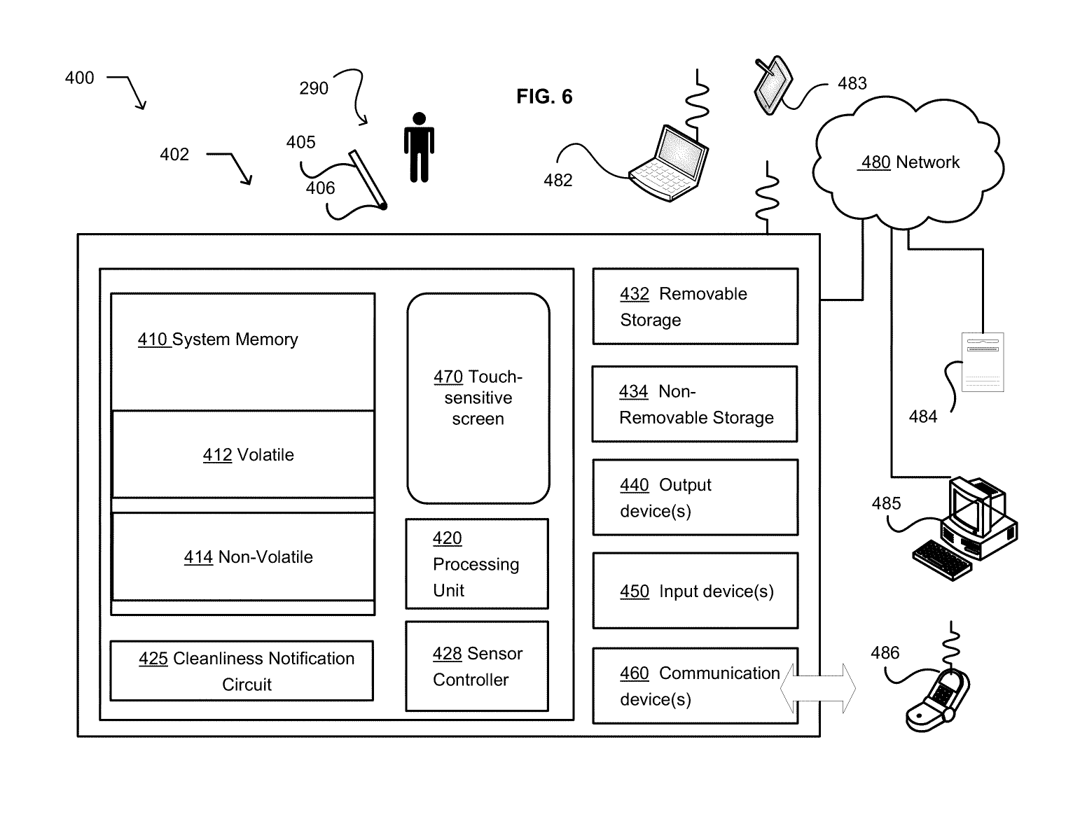

FIG. 6 illustrates an example environment 400. The environment includes a device 402, the person 290, a hand-holdable writing implement 405, a network 480, a portable computing device 482, a tablet computing device 483, a server 484, a desktop computing device 485, and a smart phone 486. In an embodiment, the hand-holdable writing implement is substantially similar to the hand-holdable device 205 described in conjunction with FIG. 3.

The device 402 includes a touch-sensitive screen 470 configured to accept an input responsive to a contact or movement by a writing element 406 of the hand-holdable writing implement 405 held by a hand of the person 290. The device includes a receiver circuit configured to receive a signal originated by the hand-holdable writing implement responsive to a detected indicator of a pathogen present on the hand of the person. The receiver circuit is illustrated by communications device(s) 460. The device includes a cleanliness notification circuit 425 configured to initiate an action responsive to the detected indicator of a pathogen on the hand of the person.

In an embodiment, the device 402 includes a computing device. In an embodiment, the computing device may include a thin computing device, such as the thin computing device 20 described in conjunction with in FIG. 1, or a general purpose computing device, such as the general purpose computing device 110 described in conjunction with FIG. 2. In an embodiment, the device 402 is configured to interact with the hand-holdable device 205 described in conjunction with FIG. 3.

In an embodiment, the detected indicator of a pathogen is sensed in response to sensing criteria. In an embodiment, the initiate an action includes initiate an action in the device 402. In an embodiment, the initiate an action includes initiate an action in the hand-holdable writing implement 405. In an embodiment, the initiate an action includes initiate an action in a third-party device. For example, the third-party device may include the portable computing device 482, the tablet computing device 483, the server 484, the desktop computing device 485, or the smart phone 486. In an embodiment, the initiate an action includes initiate a broadcast of a human perceivable indication of the detected indicator of a pathogen. In an embodiment, the initiate an action includes initiate a modification of an operation of the device 402. In an embodiment, the initiate an action includes initiate a modification of an application running on the device. In an embodiment, the initiate an action includes transmit an instruction to the hand-holdable writing implement to inactivate the writing element 406. In an embodiment, the initiate an action includes encode a mark formed on the surface of the touch-sensitive screen 470 by the writing element with information indicative of the detected indicator of a pathogen. In an embodiment, the cleanliness notification circuit 425 is configured to output a signal responsive to the detected indicator of a pathogen on the hand of the person 290 holding the hand-holdable writing implement, and indicative of a context in which the detection occurred. In an embodiment, the initiate an action includes transform the signal responsive to the detected indicator of a pathogen on the hand of the person into a particular visual indication of the detected indicator of a pathogen on the hand of the person, and output the particular visual indication.

In an embodiment, the device 402 includes a sensor controller 428 configured to initiate a sensing of the hand of the person 290 by the hand-holdable writing implement 405 in response to sensing criteria. In an embodiment, the device includes system memory 410. In an embodiment, the system memory includes volatile memory 412 or non-volatile memory 414. In an embodiment, the device includes removable storage 432. In an embodiment, the device includes non-removable storage 434. In an embodiment, the device includes a processing unit 420. In an embodiment, the device includes one or more output devices 440. In an embodiment, the device includes one or more input devices 450.

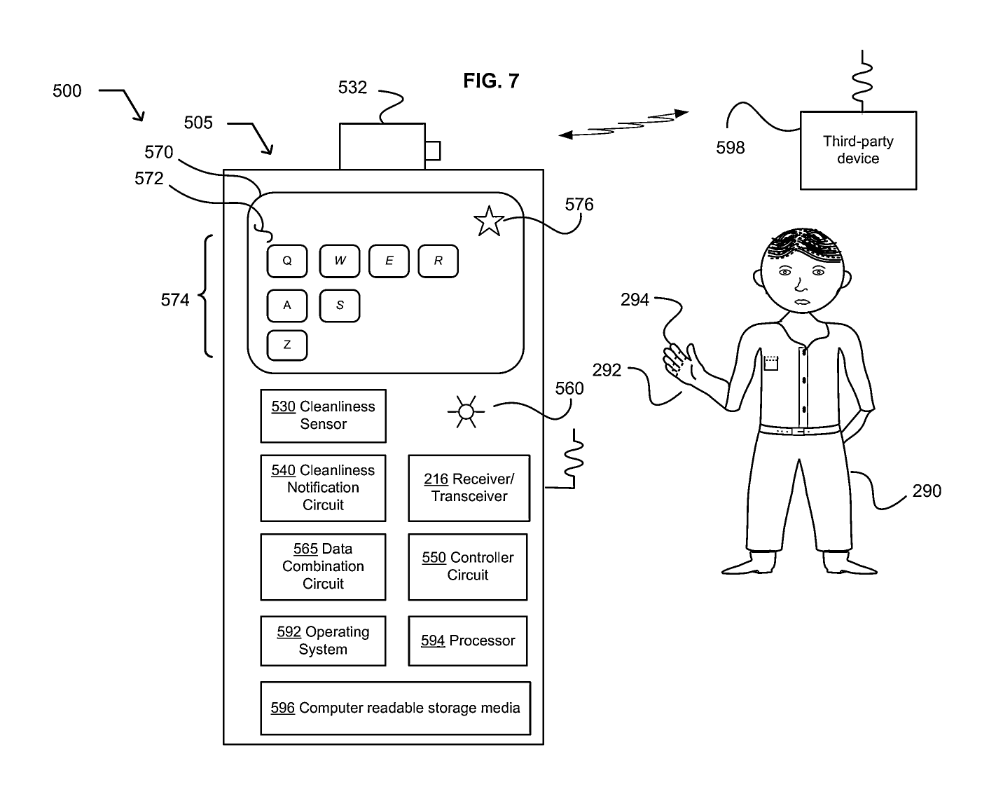

FIG. 7 illustrates an environment 500. The environment includes a computing device 505, the person 290, and a third-party device 598. The computing device includes a touch-sensitive screen 570 having a surface 572 and configured accept an input from a hand 292 of the person based upon a touch contact. The computing device includes a cleanliness sensor 530 configured to detect an indicator of a pathogen present on the hand of the person contacting the touch-sensitive screen or present on the other hand of the person. For example, the other hand of the person may be touching a cleanliness sensor carried by a housing or case of the computing device. The computing device includes a cleanliness notification circuit 540 configured to output a signal responsive to the detected indicator of a pathogen.

In an embodiment, the touch-sensitive screen 570 includes a touch-sensitive screen configured sense a finger 294 contact by the hand 292 of the person 290. In an embodiment, the touch-sensitive screen includes a touch-sensitive screen configured sense a multi-touch contact by a hand of a person. In an embodiment, the touch-sensitive screen includes a touch-sensitive screen configured sense a contact by both hands of a person. In an embodiment, the touch-sensitive screen includes a touch-sensitive screen configured sense a contact by a finger of a hand, or by fingers of both hands of a person. In an embodiment, the touch-sensitive screen includes a touch-sensitive screen configured sense a gestural contact by a hand of a person. In an embodiment, the touch contact includes a haptic touch contact.

In an embodiment, the cleanliness sensor 530 includes a cleanliness sensor configured to detect in substantially real-time an indicator of a pathogen present on the hand 292 of the person 290 contacting the touch-sensitive screen 570 or on the other hand of the person. In an embodiment, the cleanliness sensor includes a cleanliness sensor carried by the touch-sensitive screen and configured to detect an indicator of a pathogen present on the hand contacting the touch-sensitive touch screen. In an embodiment, the cleanliness sensor includes a cleanliness sensor incorporated into the touch-sensitive screen and configured to detect an indicator of a pathogen present on the hand contacting the touch-sensitive touch screen. In an embodiment, the cleanliness sensor includes a cleanliness sensor proximate to the touch-sensitive screen and configured to detect an indicator of a pathogen present on a hand of the person. In an embodiment, the cleanliness sensor includes a cleanliness sensor carried by a portion of the computing device and configured to detect an indicator of a pathogen present on the hand contacting the touch-sensitive touch screen, or the other hand of the person while holding the computing device 505. For example, the cleanliness sensor may be carried by an exterior portion of a housing or case of the computing device. In an embodiment, the cleanliness sensor includes a cleanliness sensor pad. In an embodiment, the cleanliness sensor pad includes a disposable cleanliness sensor pad. In an embodiment, the cleanliness sensor includes a cleanliness sensor located on an exterior portion of the computing device other than the touch-sensitive screen and likely to be touched by either hand of the person in a usual course of using the computing device. For example, the cleanliness sensor may be located on or proximate to a start button, an on/off switch, a fingerprint area, or a a bioID button. For example, the cleanliness sensor may be ergonomically located on an exterior portion of the computing device. In an embodiment, the cleanliness sensor is located on an exterior portion the computing device and required to be touched by either hand of the person before the computing device will accept an input from the person. For example, the requirement may be imposed by an operating system, application, or BIOS of the computing device. In an embodiment, the cleanliness sensor includes an image or optical pathogen sensor 532.

In an embodiment, the cleanliness notification circuit 540 includes a cleanliness notification circuit configured to output a signal responsive to the detected indicator of a pathogen to a third-party device. The third-party device is illustrated by the third-party device 598. For example, the third-party device may be any one of the third-party devices illustrated in FIG. 6. In an embodiment, the cleanliness notification circuit includes a cleanliness notification circuit configured to output a signal to a third-party device responsive to the detected indicator of a pathogen, and indicative of a context in which the detection occurred. In an embodiment, the cleanliness notification circuit includes a cleanliness notification circuit configured to associate a contamination report responsive to the detected indicator of a pathogen with an input to the computing device originating from a sensed contact by the hand of the person to the touch-sensitive screen.

In an embodiment, the computing device 505 includes a data combination circuit 565 configured to associate an input sensed by the touch-sensitive screen from a touch by the person and the outputted signal responsive to the detected indicator of a pathogen. In an embodiment, the computing device includes a controller circuit 550 configured to initiate a human perceivable indication of a possible contamination in response to the detected indicator of a pathogen. For example, the human perceivable indication may include blinking or flashing an indicator element 560. In an embodiment, the controller circuit includes a touch-screen controller circuit configured to inactivate the touch-sensitive screen 570 or the computing device in response to the detected indicator of a pathogen. In an embodiment, the controller circuit includes a touch-screen controller circuit configured to display a human perceivable indication of a possible contamination on the touch-screen. In an embodiment, the controller circuit includes a touch-screen controller circuit configured to initiate a human-perceivable change to a content presented by the touch-sensitive screen. For example, the human perceivable change may include graying out virtual keys 574 displayed by the touch-sensitive screen, or displaying or blinking an icon 576. In an embodiment, the controller circuit includes a touch-screen controller circuit configured to modify an operation of the touch-screen or the computing device. In an embodiment, the controller circuit includes a controller circuit configured to modify an operation of an application running on the computing device.

In an embodiment, the computing device 505 includes the indicator element configured to broadcast a human perceivable indication responsive to the signal responsive to the detected indicator of a pathogen. In an embodiment, the indicator element includes the indicator element 560 or the icon 576. In an embodiment, the human perceivable indication includes a visual change, an audible change, or a haptic change. In an embodiment, the computing device is coupled with or incorporated with a healthcare apparatus. In an embodiment, the computing device includes an operating system 592, a processor 594 and a computer readable storage media 596. In an embodiment, the computing device may include a thin computing device, such as the thin computing device 20 described in conjunction with in FIG. 1, or a general purpose computing device, such as the general purpose computing device 110 described in conjunction with FIG. 2.

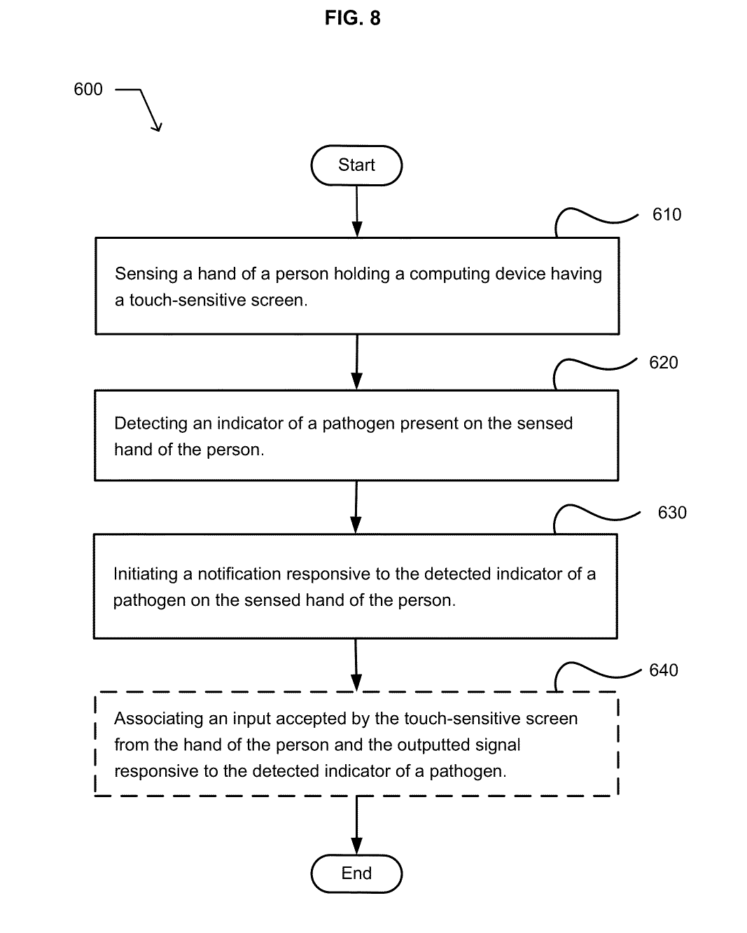

FIG. 8 illustrates an example operational flow 600. After a start operation, the operational flow includes an acquisition operation 610. The acquisition operation includes sensing a hand of a person holding or touching a computing device having a touch-sensitive screen. In an embodiment, the acquisition operation may be implemented using the cleanliness sensor 530 described in conjunction with FIG. 7. An ascertainment operation 620 includes detecting an indicator of a pathogen present on the sensed hand of the person. In an embodiment, the ascertainment operation may be implemented using the cleanliness sensor 530 described in conjunction with FIG. 7. A report operation 630 includes initiating a notification responsive to the detected indicator of a pathogen on the hand of the person. In an embodiment, the report operation may be implemented using the cleanliness notification circuit 540 described in conjunction with FIG. 7. The operational flow includes an end operation.

In an embodiment of the acquisition operation 610, the sensing includes sensing a hand of a person touching the touch-sensitive screen of a computing device. In an embodiment, the sensing includes sensing a hand of a person touching a cleanliness sensor carried by a touch-sensitive screen of a computing device. In an embodiment, the sensing includes sensing a hand of a person touching a cleanliness sensor incorporated in a touch-sensitive screen of a computing device. In an embodiment, the sensing includes sensing a hand of a person touching a cleanliness sensor carried by an exterior portion of the computing device. For example, the exterior portion of the computing device may include a housing or case of the computing device. In an embodiment, the sensing includes sensing the hand of the person holding the writing implement in response to sensing criteria.

In an embodiment of the ascertainment operation 620, the detecting includes detecting in substantially real-time an indicator of a pathogen present on the sensed hand. In an embodiment, the detecting in substantially real-time includes detecting an indicator of a pathogen present on the sensed hand within about 60 seconds from the sensing the hand of the person. In an embodiment, the detecting in substantially real-time includes detecting an indicator of a pathogen present on the sensed hand within about 30 seconds from the sensing the hand of the person. In an embodiment, the detecting in substantially real-time includes detecting an indicator of a pathogen present on the sensed hand within about 10 seconds from the sensing the hand of the person. In an embodiment, the detecting in substantially real-time includes detecting an indicator of a pathogen present on the sensed hand within about 5 seconds from the sensing the hand of the person. In an embodiment, the detecting includes detecting a cleanliness surrogate indicative of a pathogen present on the sensed hand. In an embodiment, the detecting includes electronically detecting odors or flavors indicative of a pathogen present on the sensed hand. In an embodiment, the detecting includes electronically detecting airborne particles indicative of a pathogen present on the sensed hand. In an embodiment, the detecting includes detecting an indicator of a pathogen present on the sensed hand using a wetness sensitive polymer. In an embodiment, the detecting includes detecting an indicator of a pathogen present on the sensed hand using a real-time optical pathogen sensor. In an embodiment, the detecting includes detecting an indicator of a pathogen present on the hand of the person using a biosensor. In an embodiment, the detecting includes detecting an indicator of a pathogen present on the sensed hand using a piezoelectric sensor. In an embodiment, the detecting includes detecting an indicator of a pathogen present on the sensed hand using a microbe-sensitive chromogen that undergoes a detectable color change in the presence of one or more microbes. In an embodiment, the detecting includes detecting an indicator of a pathogen present on the sensed hand using an impedimetric biosensor.

In an embodiment of the reporting operation 630, the initiating includes initiating a human-perceivable notification responsive to the detected indicator of a pathogen on the sensed hand. In an embodiment, the initiating includes transforming the detected indicator of a pathogen on the hand of the person into a particular visual indication of the detected indicator of a pathogen on the sensed hand, and outputting the particular visual indication. In an embodiment, the initiating includes transforming the detected indicator of a pathogen on the hand of the person into data usable in displaying a particular visual indication of the detected indicator of a pathogen on the sensed hand. In an embodiment, the initiating includes initiating a notification to at least one of a human, computer, or system in response to the detected indicator of a pathogen on the sensed hand. In an embodiment, the initiating includes providing a notification to at least one of a human, computer, or system in response to the detected indicator of a pathogen on the sensed hand. In an embodiment, the initiating includes electronically outputting information indicative of the detected indicator of a pathogen on the hand of the person. In an embodiment, the initiating includes electronically outputting a signal useable in displaying a human-perceivable indication of the detected indicator of a pathogen on the sensed hand.

In an embodiment, the operational flow 600 further includes an operation 640 associating an input accepted by the touch-sensitive screen from the hand of the person and the outputted signal responsive to the detected indicator of a pathogen.

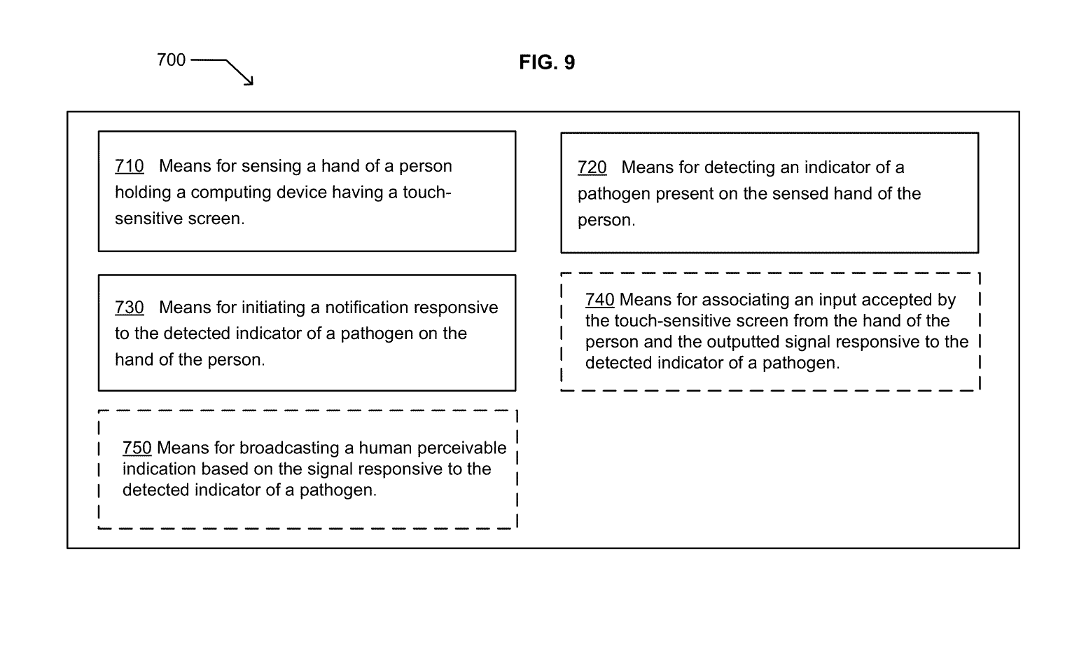

FIG. 9 illustrates a system 700. The system includes means 710 for sensing a hand of a person holding a computing device having a touch-sensitive screen. The system includes means 720 for detecting an indicator of a pathogen present on the sensed hand of the person. The system includes means 730 for initiating a notification responsive to the detected indicator of a pathogen on the hand of the person.

In an embodiment, the system 700 includes means 740 for associating an input accepted by the touch-sensitive screen from the hand of the person and the outputted signal responsive to the detected indicator of a pathogen. In an embodiment, the system includes means 750 for broadcasting a human perceivable indication based on the signal responsive to the detected indicator of a pathogen

All references cited herein are hereby incorporated by reference in their entirety or to the extent their subject matter is not otherwise inconsistent herewith.

In some embodiments, “configured” includes at least one of designed, set up, shaped, implemented, constructed, or adapted for at least one of a particular purpose, application, or function.

It will be understood that, in general, terms used herein, and especially in the appended claims, are generally intended as “open” terms. For example, the term “including” should be interpreted as “including but not limited to.” For example, the term “having” should be interpreted as “having at least.” For example, the term “has” should be interpreted as “having at least.” For example, the term “includes” should be interpreted as “includes but is not limited to,” etc. It will be further understood that if a specific number of an introduced claim recitation is intended, such an intent will be explicitly recited in the claim, and in the absence of such recitation no such intent is present. For example, as an aid to understanding, the following appended claims may contain usage of introductory phrases such as “at least one” or “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a receiver” should typically be interpreted to mean “at least one receiver”); the same holds true for the use of definite articles used to introduce claim recitations. In addition, even if a specific number of an introduced claim recitation is explicitly recited, it will be recognized that such recitation should typically be interpreted to mean at least the recited number (e.g., the bare recitation of “at least two chambers,” or “a plurality of chambers,” without other modifiers, typically means at least two chambers).

In those instances where a phrase such as “at least one of A, B, and C,” “at least one of A, B, or C,” or “an [item] selected from the group consisting of A, B, and C,” is used, in general such a construction is intended to be disjunctive (e.g., any of these phrases would include but not be limited to systems that have A alone, B alone, C alone, A and B together, A and C together, B and C together, or A, B, and C together, and may further include more than one of A, B, or C, such as A₁, A₂, and C together, A, B₁, B₂, C₁, and C₂ together, or B₁ and B₂ together). It will be further understood that virtually any disjunctive word or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The herein described aspects depict different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality. Any two components capable of being so associated can also be viewed as being “operably couplable” to each other to achieve the desired functionality. Specific examples of operably couplable include but are not limited to physically mateable or physically interacting components or wirelessly interactable or wirelessly interacting components.

With respect to the appended claims the recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Use of “Start,” “End,” “Stop,” or the like blocks in the block diagrams is not intended to indicate a limitation on the beginning or end of any operations or functions in the diagram. Such flowcharts or diagrams may be incorporated into other flowcharts or diagrams where additional functions are performed before or after the functions shown in the diagrams of this application. Furthermore, terms like “responsive to,” “related to,” or other past-tense adjectives are generally not intended to exclude such variants, unless context dictates otherwise.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A computing device comprising:
a touch-sensitive screen configured to accept an input from a hand of a person based upon a touch contact;
a cleanliness sensor configured to detect an indicator of a pathogen present on the hand of the person contacting the touch-sensitive screen or present on the other hand of the person; and
a cleanliness notification circuit configured to output a signal responsive to the detected indicator of a pathogen.

2. The computing device of claim 1, wherein the touch-sensitive screen includes a touch-sensitive screen configured to sense a fingertip contact by a hand of a person.

3. The computing device of claim 1, wherein the touch-sensitive screen includes a touch-sensitive screen configured to sense a multi-touch contact by a hand of a person.

4. (canceled)

5. The computing device of claim 1, wherein the touch-sensitive screen includes a touch-sensitive screen configured to sense a contact by a finger of a hand, or by fingers of both hands of a person.

6. The computing device of claim 1, wherein the touch-sensitive screen includes a touch-sensitive screen configured to sense a gestural contact by a hand of a person.

7. (canceled)

8. The computing device of claim 1, wherein the cleanliness sensor includes a cleanliness sensor configured to detect in substantially real-time an indicator of a pathogen present on the hand of the person contacting the touch-sensitive screen or on the other hand of the person.

9. The computing device of claim 1, wherein the cleanliness sensor includes a cleanliness sensor carried by the touch-sensitive screen and configured to detect an indicator of a pathogen present on the hand contacting the touch-sensitive touch screen.

10. The computing device of claim 1, wherein the cleanliness sensor includes a cleanliness sensor incorporated into the touch-sensitive screen and configured to detect an indicator of a pathogen present on the hand contacting the touch-sensitive touch screen.

11. The computing device of claim 1, wherein the cleanliness sensor includes a cleanliness sensor proximate to the touch-sensitive screen and configured to detect an indicator of a pathogen present on a hand of the person.

12. The computing device of claim 1, wherein the cleanliness sensor includes a cleanliness sensor carried by a portion of the computing device and configured to detect an indicator of a pathogen present on the hand contacting the touch-sensitive touch screen or the other hand of the person.

13.-14. (canceled)

15. The computing device of claim 1, wherein the cleanliness sensor includes a cleanliness sensor located on an exterior portion of the computing device other than the touch-sensitive screen and likely to be touched by either hand of the person in a usual course of using the computing device.

16. The computing device of claim 1, wherein the cleanliness sensor includes a cleanliness sensor located on an exterior portion the computing device and required to be touched by either hand of the person before the computing device will accept input from the person.

17. The computing device of claim 1, wherein the cleanliness notification circuit includes a cleanliness notification circuit configured to output a signal responsive to the detected indicator of a pathogen to a third-party device.

18.-19. (canceled)

20. The computing device of claim 1, further comprising:
a data combination circuit configured to associate an input sensed by the touch-sensitive screen from a touch by the person and the outputted signal responsive to the detected indicator of a pathogen.

21. The computing device of claim 1, further comprising:
a controller circuit configured to initiate a human perceivable indication of a possible contamination in response to the detected indicator of a pathogen.

22.-26. (canceled)

27. The computing device of claim 1, further comprising:
an indicator element configured to broadcast a human perceivable indication responsive to the signal responsive to the detected indicator of a pathogen.

28. The computing device of claim 27, wherein the human perceivable indication includes a visual change, an audible change, or a haptic change.

29. The computing device of claim 1, further comprising:
a healthcare apparatus physically coupled with or incorporating the computing device.

30. The computing device of claim 1, further comprising:
an operating system;
a processor; and
computer readable storage media.

31. A method comprising:
sensing a hand of a person holding or touching a computing device having a touch-sensitive screen;
detecting an indicator of a pathogen present on the sensed hand of the person; and
initiating a notification responsive to the detected indicator of a pathogen on the hand of the person.

32. The method of claim 31, wherein the sensing includes sensing a hand of a person touching the touch-sensitive screen of a computing device.

33. The method of claim 31, wherein the sensing includes sensing a hand of a person touching a cleanliness sensor carried by a touch-sensitive screen of a computing device.

34. The method of claim 31, wherein the sensing includes sensing a hand of a person touching a cleanliness sensor incorporated in a touch-sensitive screen of a computing device.

35. The method of claim 31, wherein the sensing includes sensing a hand of a person touching a cleanliness sensor carried by an exterior portion of the computing device.

36. The method of claim 31, wherein the sensing includes sensing the hand of the person holding the writing implement in response to sensing criteria.

37. The method of claim 31, wherein the detecting includes detecting in substantially real-time an indicator of a pathogen present on the sensed hand.

38. The method of claim 37, wherein the detecting in substantially real-time includes detecting an indicator of a pathogen present on the sensed hand within about 60 seconds from sensing the hand of the person.

39.-40. (canceled)

41. The method of claim 37, wherein the detecting in substantially real-time includes detecting an indicator of a pathogen present on the sensed hand within about 5 seconds from sensing the hand of the person.

42. The method of claim 31, wherein the detecting includes detecting a cleanliness surrogate indicative of a pathogen present on the sensed hand.

43. The method of claim 31, wherein the detecting includes electronically detecting odors or flavors indicative of a pathogen present on the sensed hand.

44. The method of claim 31, wherein the detecting includes electronically detecting airborne particles indicative of a pathogen present on the sensed hand.

45. The method of claim 31, wherein the detecting includes detecting an indicator of a pathogen present on the sensed hand using a wetness sensitive polymer.

46. The method of claim 31, wherein the detecting includes detecting an indicator of a pathogen present on the sensed hand using a real-time optical pathogen sensor.

47. The method of claim 31, wherein the detecting includes detecting an indicator of a pathogen present on the hand of the person using a biosensor.

48. The method of claim 31, wherein the detecting includes detecting an indicator of a pathogen present on the sensed hand using a piezoelectric sensor.

49. The method of claim 31, wherein the detecting includes detecting an indicator of a pathogen present on the sensed hand using a microbe-sensitive chromogen that undergoes a detectable color change in the presence of one or more microbes.

50. The method of claim 31, wherein the detecting includes detecting an indicator of a pathogen present on the sensed hand using an impedimetric biosensor.

51. The method of claim 31, wherein the initiating includes initiating a human-perceivable notification responsive to the detected indicator of a pathogen on the sensed hand.

52. The method of claim 31, wherein the initiating includes transforming the detected indicator of a pathogen on the hand of the person into a particular visual indication of the detected indicator of a pathogen on the sensed hand, and outputting the particular visual indication.

53. The method of claim 31, wherein the initiating includes transforming the detected indicator of a pathogen on the hand of the person into data usable in displaying a particular visual indication of the detected indicator of a pathogen on the sensed hand.

54. (canceled)

55. The method of claim 31, wherein the initiating includes providing a notification to at least one of a human, computer, or system in response to the detected indicator of a pathogen on the sensed hand.

56. The method of claim 31, wherein the initiating includes electronically outputting information indicative of the detected indicator of a pathogen on the hand of the person.

57. (canceled)

58. The method of claim 31, further comprising:
associating an input accepted by the touch-sensitive screen from the hand of the person and the outputted signal responsive to the detected indicator of a pathogen.

59. A system comprising:
means for sensing a hand of a person holding a computing device having a touch-sensitive screen;
means for detecting an indicator of a pathogen present on the sensed hand of the person; and
means for initiating a notification responsive to the detected indicator of a pathogen on the hand of the person.

60. The system of claim 59, further comprising:
means for associating an input accepted by the touch-sensitive screen from the hand of the person and the outputted signal responsive to the detected indicator of a pathogen.

61. The system of claim 59, further comprising:
means for broadcasting a human perceivable indication based on the signal responsive to the detected indicator of a pathogen.
